(19) United States
(12) Patent Application Publication
(10) Pub. No.: US 2006/0125798 A1
(43) Pub. Date: Jun. 15, 2006

(54) Continuous Scrolling Using Touch Pad

(75) Inventor: Victor Marten, Flushing, NY (US)

Correspondence Address: OPPEDAHL & OLSON LLP, P.O. BOX 5388, DILLON, CO, 80435-5388, US

(73) Assignee: SEMTECH CORPORATION, Camarillo, CA (US)

(21) Appl. No.: 11/275,096

(22) Filed: Dec. 9, 2005

Related U.S. Application Data
(60) Provisional application No. 60/593,159, filed on Dec. 15, 2004.

(51) Int. Cl. G09G 5/00

(52) U.S. Cl. 345/173

(57) ABSTRACT

A method for evoking the scrolling and panning operations utilizing the touch pad is disclosed, characterized by the ability to perform continuous scrolling or panning, with user selectable trade-off between the speed and accuracy.

### CROSS-REFERENCE TO RELATED APPLICATIONS

This application claims priority from U.S. application No. 60/593,159 filed Dec. 15, 2004, which application is incorporated herein by reference for all purposes.

### BACKGROUND

The majority of modern computing devices utilize a Graphical User Interface (GUI) for interactions with users. A common operation with such a GUI is scrolling or panning of the text or graphics displayed by the computing device. A popular device capable of evoking the scrolling or panning is a familiar computer mouse with a scroll wheel on top. However, many portable and self-contained devices often have only a touch pad pointing device, without any wheels or moving parts. It is very desirable to effect the same scrolling and panning capability for such portable devices as for the devices that are equipped with a mouse or scroll wheel.

Several previous patents deal with methods for effecting the scrolling and panning operations. Typically, several areas are reserved on the face of the touch pad for use in scrolling or panning operations. In one prior patent, for example, when a user touches the right-most edge of the Touch Pad, the scrolling information is sent to the GUI instead of the “normal” positioning information, typically by combined action of the touch pad and the corresponding driver software residing on the computing device.

However, the range of motion available on the edge of the touch pad is quite limited. Typically, the scrolling operation continues with some constant and predetermined speed when the user reaches the end of the allowed area. The scrolling or panning operations cease when he user stops touching the pad, or moves the point of contact onto the unreserved area.

It would thus be very desirable if an approach could be devised by which a user could achieve continuous scrolling and panning, with fine control of the scrolling and panning. It would be very desirable if the user were able to have continuous fine control of the scrolling and panning. It would be desirable if the user were able to select whether to effect comparatively fast scrolling and panning, utilizing only a relatively small motion of the point of contact with the touch pad, or to achieve slow scrolling and panning employing relatively large motion of the point of contact with the touch pad.

### SUMMARY OF THE INVENTION

As will be described in more detail below, the operations made possible by the current invention allow for continuous scrolling and panning.

Furthermore, the user has continuous fine control of the scrolling and panning.

Moreover, the user can select whether to effect comparatively fast scrolling and panning, utilizing only small relative motion of the point of contact with the touch pad, or achieve slow scrolling and panning employing relatively large motion of the point of contact with the touch pad.

### DESCRIPTION OF THE DRAWING

The invention will be described with respect to a drawing in several figures, of which:

FIG. 1 illustrates the Scroll Down process.

FIG. 2 depicts the Scroll Up process.

FIG. 3 shows the Pan Left process.

FIG. 4 demonstrates the Scroll Down process with user-selectable ratio between the motion of the point of contact with the Pad and scrolling distance.

FIG. 5 illustrates reserved Start Areas used to evoke the scrolling and panning processes.

FIG. 6depicts alternate shapes for the Start Areas used to evoke the scrolling and panning processes, with maximum surface of the pad allocated to the pointing operations.

FIG. 7 depicts exemplary hardware and software for practicing the invention.

### DETAILED DESCRIPTION

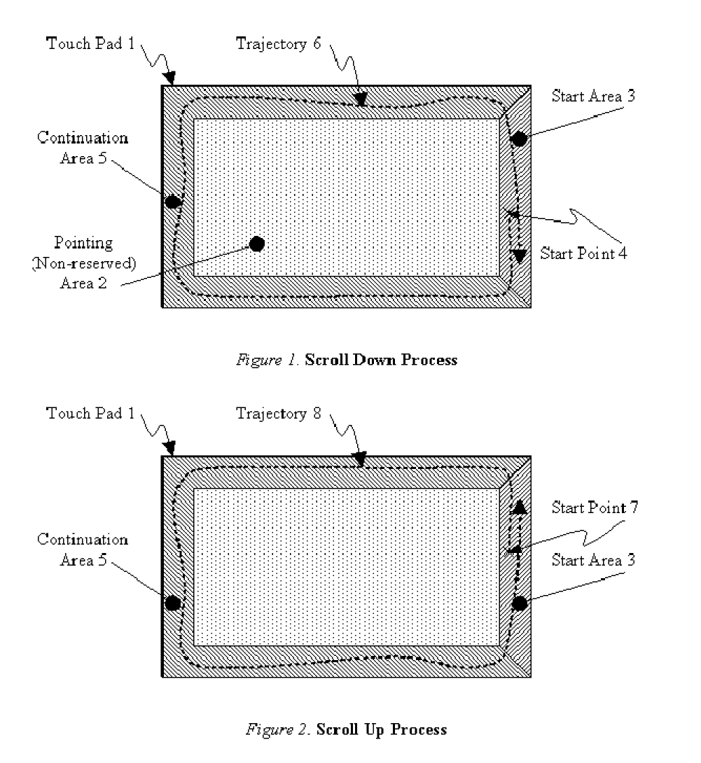

When the user first makes a touch at the point 4 within a reserved area (Start Area) 3 on Touch Pad 1, without touching any other areas of Touch Pad, and without sliding the point of contact from the Pointing Area 2 to the Start Area 3, the scrolling process begins. However, unlike the previous approaches, the scrolling operations continue as long as the point of contact with the touch pad stays within the reserved areas 3 and 5, for example following Trajectory 6. FIG. 1 illustrates the Scroll Down process, and FIG. 2 depicts the Scroll Up process.

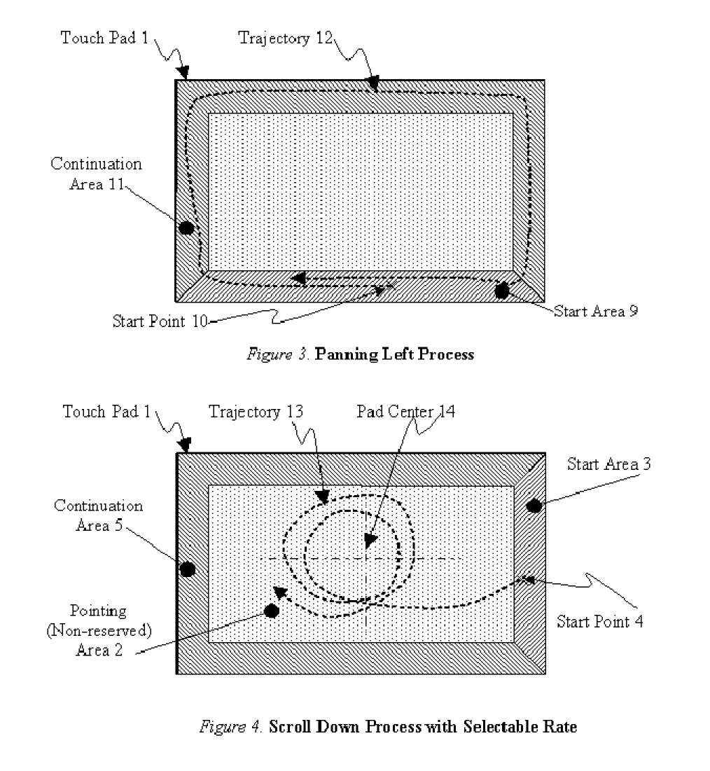

Likewise, if the user originates the contact in Start Area 9 (FIG. 3), the panning operation is performed.

For users requiring extended panning or scrolling, operations per FIG. 4 allow for proportional, continuous, and immediate control of the panning or scrolling distance versus the motion of the contact point. If the user chooses, the motion of the contact point can be small, centered around and located close to the pad center 14. This results in fast scrolling, with relatively poor resolution. However, motion following a large circular path around the pad center 14 produces a slower scrolling with relatively high resolution.

The switch between normal pointing operations and various scrolling and panning operations is produced by the combined intelligence in the touch pad controller and the driver interfacing to GUI.

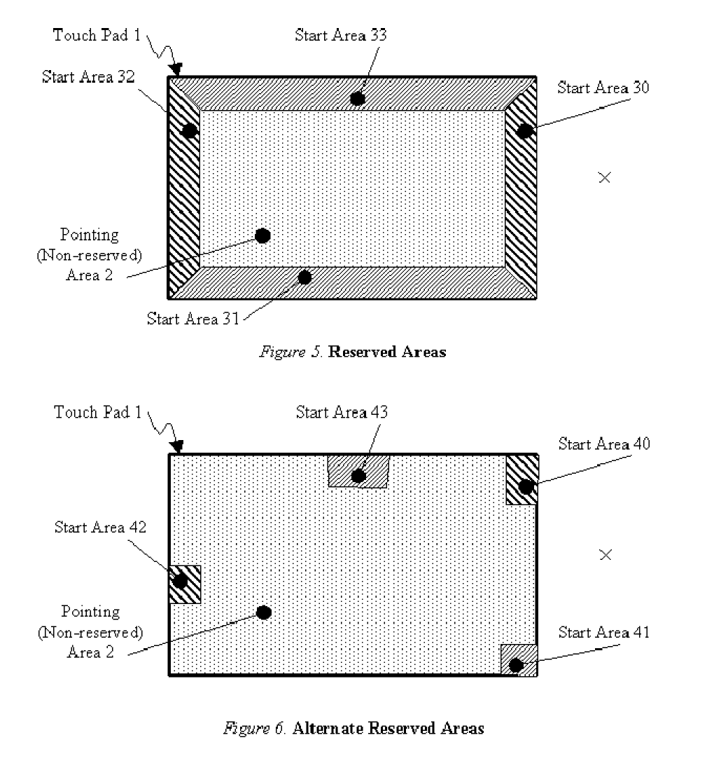

Scrolling and panning operations are started when the initial contact point falls within reserved areas, such as depicted in FIG. 5. If the initial contact takes place in Start Areas 30 or 32, then a scrolling process is started. If the initial contact occurs in Start Areas 31 and 33, then panning operations are initiated.

Both scrolling and panning operations stop when the user breaks the contact with the pad.

It will be appreciated that the Start Areas do not need to occupy the whole side of a pad. Some alternate shapes for the Start Areas are illustrated in FIG. 6, that allows for the pointing operations to utilize larger portion of the total pad's area. The number, shape and position of each of the Start Areas could be adjusted according to the functions of the computing device. The exact operation evoked by an initial touch in the Start Area 40, 41, 42, or 43 may be programmable in the Driver, suited for and synergetic with the operations of the computing device. These “Start Area to Action” assignments may be change as required in the course of the computing device's operations.

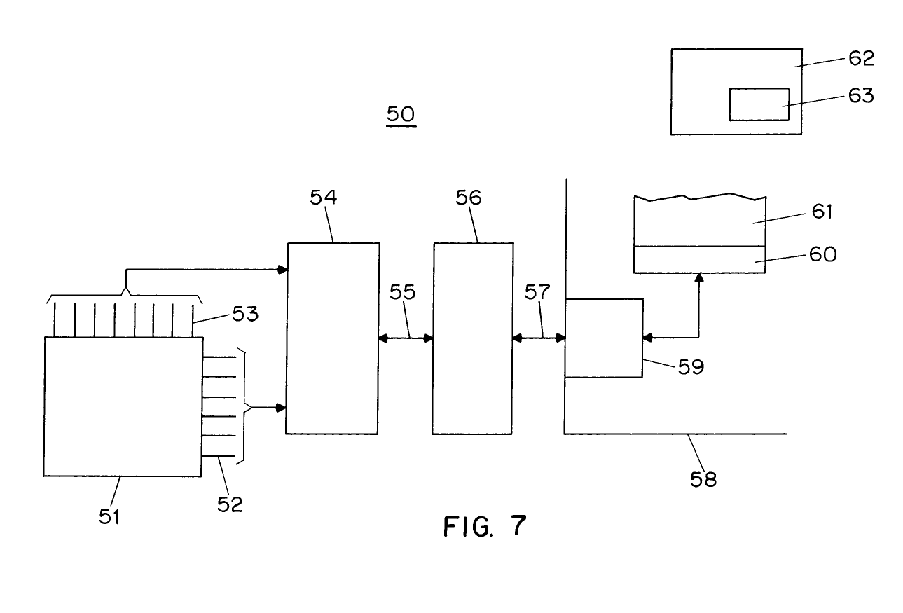

FIG. 7 depicts exemplary hardware and software for practicing the invention. Touch pad 51 has a plurality of horizontal electrodes 52 which determine vertical position, and a plurality of vertical electrodes 53 which determine horizontal position. These electrodes are connected electrically with analog chip 54 which performs analysis upon the electrical characteristics of the electrode lines. It will be appreciated that analog chip 54 may for example be performing capacitive sensing or resistive sensing. Sensing approaches may include those disclosed in PCT publication WO 2004/112448 entitled “Sensor for Capacitive Touch Pad Pointing Device” and PCT publication WO 2004/040538 entitled “Data Acquisition From Capacitive Touch Pad”, each of which designates the United States, each of which is assigned to the same assignee as the present invention, and each of which is incorporated herein by reference for all purposes.

Outputs from the analog chip 54 are communicated via line 55 to digital chip 56. This chip converts touchpad physical information (e.g. information about the capacitance at each line) into X-Y coordinate information, as well as finger-down and finger-up event information, which is communicated via line 57 as scan-code data. This data reaches a virtual 8042 chip 59 and eventually reaches a driver 60 within the execution space 61 of the computer or other device 58. Cursor movement takes place in GUI 62 which may contain windows 63 associated with particular tasks.

It will be appreciated that although this allocation of circuitry, with analog functions in a first chip 54 and digital functions in a second chip 56, is considered preferable, such functions could be achieved with a single chip without departing in any way from the invention.

In a very simple case, the only information communicated from the touch pad 51 to the device 58 is X-Y information and finger-down/up information. In some prior art systems, the information received in the device 58 may also be scroll or pan information; firmware or driver functions will convert certain user inputs into scroll commands received at the GUI.

PCT publication WO 2005/018129 entitled “Improved Gesture Recognition for Pointing Devices”, which designates the United States, which is assigned to the same assignee as the present invention, and which is incorporated herein by reference for all purposes, describes a way to recognize gestures by a user.

The hardware, firmware, and driver software in the system 50 (FIG. 7) when disposed according to the invention, achieve the results described above with respect to FIGS. 1-6. In an exemplary embodiment the results are achieved in the driver 60. The driver detects if a finger-down event has occurred in one of the Start Areas, for example. If such an event has occurred in such an area, then what is passed to the GUI 62 is a scroll event or pan event as described above. Ways of passing scroll events and pan events to operating systems are well known, for example WM_VSCROLL messages. One patent discussing such well known ways is U.S. Pat. No. 5,530,455, incorporated herein by reference.

The invention will now be described from a different point of view. What is described includes a method for use with a touch pad having an area (for example, reference designation 1 in FIG. 1) and a periphery and a graphical user interface, and with first and second predefined areas (reference designations 3 and 5 in FIG. 1) which together comprise the periphery of the touch pad, the first and second predefined areas comprising less than all of the area of the touch pad and thereby surrounding a third predefined central area (reference designation 2 in FIG. 1). In this method, a finger-down event is detected at a start point (reference designation 4 in FIG. 1) in the first predefined area 3. Next, in the absence of a finger-up event, what is detected is movement of the finger in a clockwise or counterclockwise direction about the periphery of the touch pad and within the first and second predetermined areas (for example, the clockwise trajectory 6 in FIG. 1). When this happens, the system carries out scrolling or panning within the graphical user interface in an ever-increasing manner so long as the clockwise or counterclockwise movement continues.

Thus, for example, as shown in FIG. 1 the first predefined area 3 may comprise a right edge of the touch pad 1 and clockwise movement (trajectory 6) may comprise downward scrolling. As shown in FIG. 2, the first predefined area 3 comprises a right edge of the touch pad 1 and counterclockwise movement (trajectory 8) may comprise upward scrolling. As shown in FIG. 3, the first predefined area 9 may comprise a bottom edge of the touch pad 1 and clockwise movement (trajectory 1 2) may comprise leftward panning. Alternatively, the first predefined area may comprise a bottom edge of the touch pad and clockwise movement may comprise leftward panning.

As another example, there is described a method for use with a touch pad (for example, reference designation 1 in FIG. 4) having an area and a graphical user interface, and with a first predefined area (for example, reference designation 3 in FIG. 4) of the touch pad, the first predefined area comprising less than all of the area of the touch pad. First, a finger-down event is detected (start point 4 in FIG. 4) in the first predefined area (start area 3 in FIG. 4). Next, in the absence of a finger-up event, movement of the finger in a clockwise or counterclockwise direction (trajectory 13 in FIG. 4) at the touch pad 1. As a consequence, scrolling or panning is carried out within the graphical user interface in an ever-increasing manner so long as the clockwise or counterclockwise movement continues.

Thus, as an example, in FIG. 4 the first predefined area 3 comprises an area at a right edge of the touch pad 1 and clockwise movement (trajectory 13) comprises downward scrolling. Alternatively, the first predefined area 3 may comprise an area at a right edge of the touch pad and counterclockwise movement comprises upward scrolling. As yet another example the first predefined area may comprise an area (for example, start area 31 in FIG. 5) at a bottom edge of the touch pad and counterclockwise movement may comprise rightward panning. Finally, the first predefined area may comprise an area at a bottom edge of the touch pad and clockwise movement may comprise leftward panning.

It will be appreciated that numerous and diverse obvious variations and improvements to the invention can be made without departing in any way from the invention, and all of which are intended to be embraced within the claims which follow.

What is claimed is:

1. A method for use with a touch pad having an area and a periphery and a graphical user interface, and with first and second predefined areas which together comprise the periphery of the touch pad, the first and second predefined areas comprising less than all of the area of the touch pad and thereby surrounding a third predefined central area, the method comprising the steps of:
detecting a finger-down event in the first predefined area;
detecting, in the absence of a finger-up event, movement of the finger in a clockwise or counterclockwise direction about the periphery of the touch pad and within the first and second predetermined areas; and
carrying out scrolling or panning within the graphical user interface in an ever-increasing manner so long as the clockwise or counterclockwise movement continues.

2. The method of claim 1 wherein the first predefined area comprises a right edge of the touch pad and clockwise movement comprises downward scrolling.

3. The method of claim 1 wherein the first predefined area comprises a right edge of the touch pad and counterclockwise movement comprises upward scrolling.

4. The method of claim 1 wherein the first predefined area comprises a bottom edge of the touch pad and counterclockwise movement comprises rightward panning.

5. The method of claim 1 wherein the first predefined area comprises a bottom edge of the touch pad and clockwise movement comprises leftward panning.

6. A method for use with a touch pad having an area and a graphical user interface, and with a first predefined area of the touch pad, the first predefined area comprising less than all of the area of the touch pad, the method comprising the steps of:
detecting a finger-down event in the first predefined area;
detecting, in the absence of a finger-up event, movement of the finger in a clockwise or counterclockwise direction at the touch pad; and
carrying out scrolling or panning within the graphical user interface in an ever-increasing manner so long as the clockwise or counterclockwise movement continues.

7. The method of claim 6 wherein the first predefined area comprises an area at a right edge of the touch pad and clockwise movement comprises downward scrolling.

8. The method of claim 6 wherein the first predefined area comprises an area at a right edge of the touch pad and counterclockwise movement comprises upward scrolling.

9. The method of claim 6 wherein the first predefined area comprises an area at a bottom edge of the touch pad and counterclockwise movement comprises rightward panning.

10. The method of claim 6 wherein the first predefined area comprises an area at a bottom edge of the touch pad and clockwise movement comprises leftward panning.
